(19) United States
(12) Patent Application Publication
(10) Pub. No.: US 2025/0145090 A1
(43) Pub. Date: May 8, 2025

(54) Display and Securement Devie

(71) Applicant: Clifford Davis, JR.

(72) Inventor: Clifford Davis, JR.

(21) Appl. No.: 18/502,184

(22) Filed: Nov. 6, 2023

(51) Int. Cl. B60R 11/00

(52) U.S. Cl. CPC B60R 11/00; B60R 2011/004; B60R 2011/0049

(57) ABSTRACT

The present disclosure provides a bracket 10 which may be reversibly attached to an automobile which receives an insert 24. The bracket 10 has many uses: (i) first, it allows for the personalization and decoration of an automobile and (ii) it allows for the securement of articles to the automobile.

### CROSS REFERENCE TO RELATED APPLICATIONS

This application claims priority to, and the benefit of, pending U.S. Provisional Patent Application No. 63/422,474, filed Nov. 4, 2022.

### FIELD OF THE DISCLOSURE

The present disclosure pertains to the field displays and securement devices. More specifically, the present disclosure pertains to a device that allows for interchangeable displays or fixtures on vehicles or structures.

### BACKGROUND

The automobile may be the ultimate symbol of America. As such, people often like to personalize their automobiles through stickers, magnets, personalize tags and the like. However, some of these type of items used for personalization can be permanent, not visible in low light settings or damage the automobile's finish. Additionally, it may be convenient to have a device that allows for the reversible securement of certain items, such as drink holders or firearms on the outside of a vehicle. The present disclosure provides a device that can provide both to users and addresses these needs not met by the prior art.

### BRIEF DESCRIPTION OF THE DRAWINGS

To further illustrate the advantages and features of the present disclosure, a more particular description of the invention will be rendered by reference to specific embodiments thereof which are illustrated in the appended drawings. It is appreciated that these drawings are not to be considered limiting in scope. The invention will be described and explained with additional specificity and detail through the use of the accompanying drawings in which:

FIG. 1 shows a front elevated view one embodiment of the bracket 10 of the present disclosure.

FIG. 2 shows a perspective view of one embodiment of the bracket 10 of the present disclosure.

FIG. 3 shows a front elevated view of one embodiment of the bracket 10 of the present disclosure.

FIG. 4 shows a rear perspective view of one embodiment of the bracket 10 of the present disclosure.

FIG. 5 shows a front view of one embodiment of an insert 24 of the present disclosure.

FIG. 6 shows a perspective view of one embodiment of an insert 24 disposed into the bracket 10.

FIG. 7 shows a perspective view of one embodiment of an insert 24 partially disposed into the bracket 10.

FIGS. 8A-D show various embodiments of the opposing sides 12 of the present disclosure.

### DETAILED DESCRIPTION

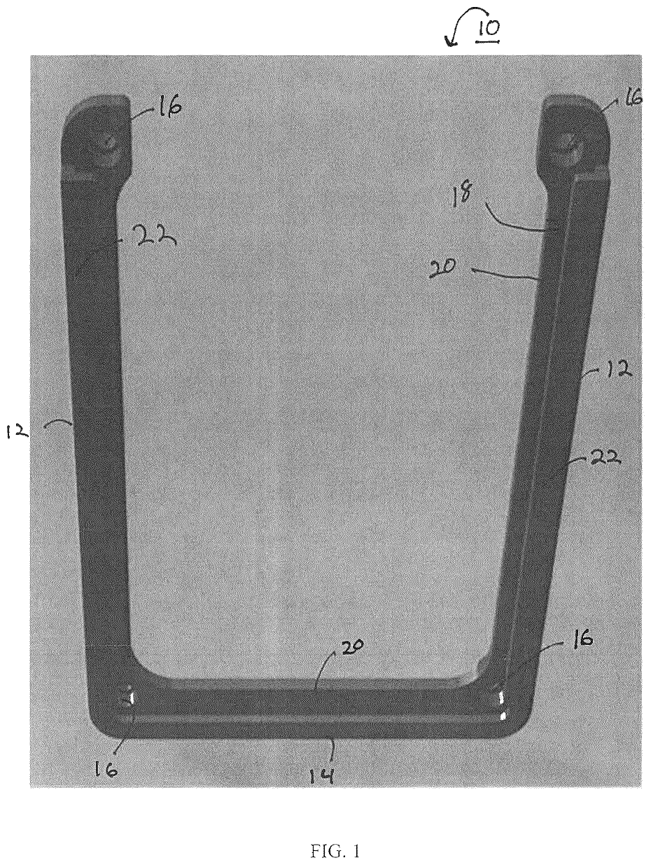

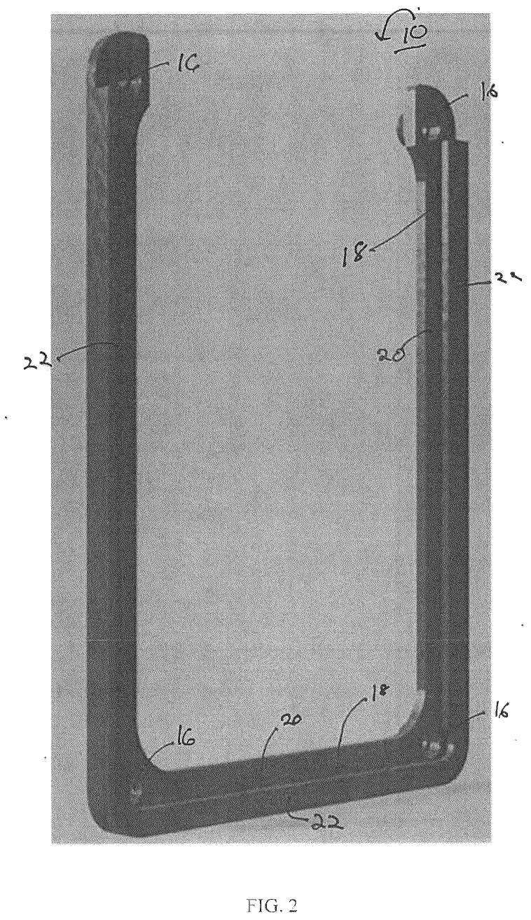

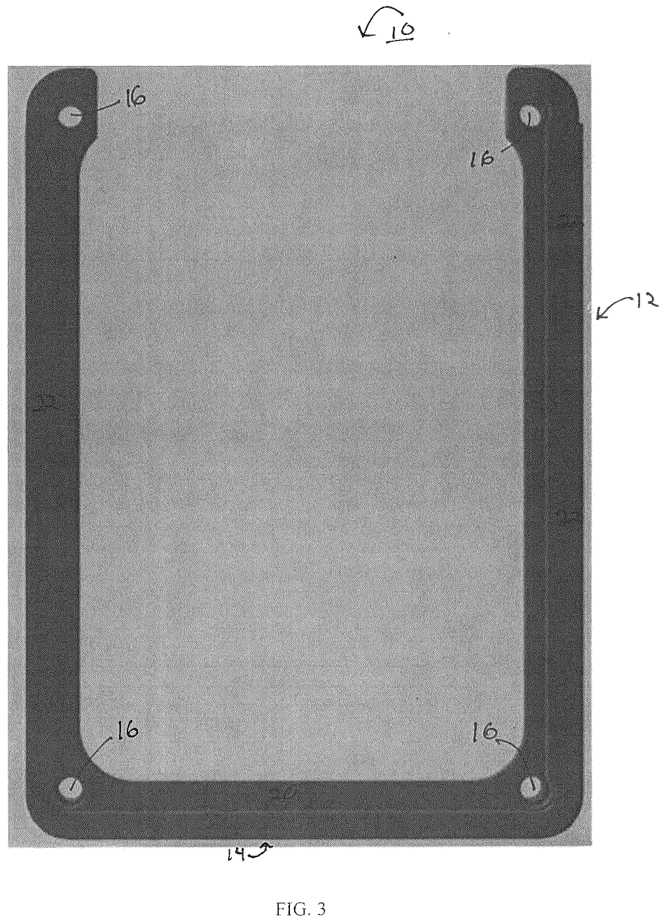

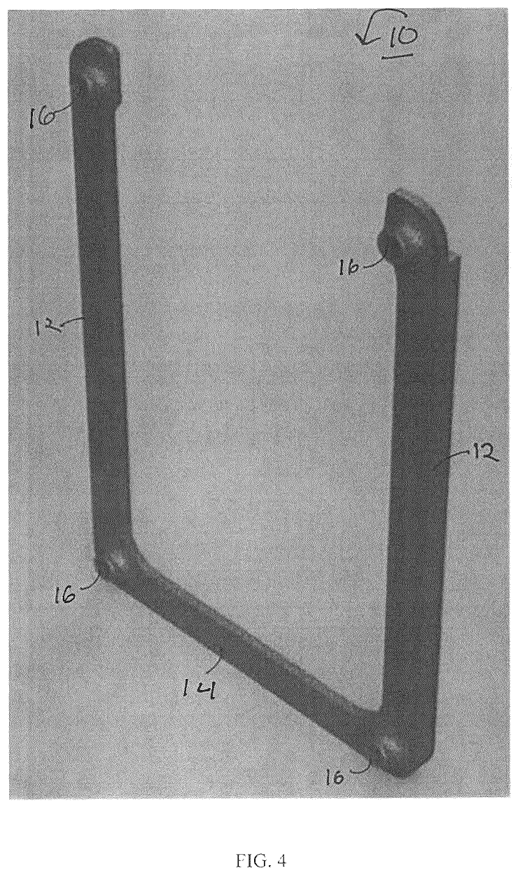

Now referring to FIGS. 1-8D, the present disclosure provides a bracket 10 which may be reversibly attached to an automobile (as shown) which receives an insert 24. The bracket 10 has many uses: (i) first, it allows for the personalization and decoration of an automobile and (ii) it allows for the securement of articles to the automobile.

The bracket 10 allows personalization of automobiles as it may alternatively adapted to be affixed over the taillight (otherwise known as the brake light) of an automobile or, in an alternate embodiment (not shown), adapted to be affixed to a flat or nearly flat surface of an automobile by magnetic or other means. In the embodiment in which the bracket 10 is affixed over a taillight, when an insert 24 and the taillight is illuminated, the insert 24 is prominently displayed as it is effectively backlight by the taillight.

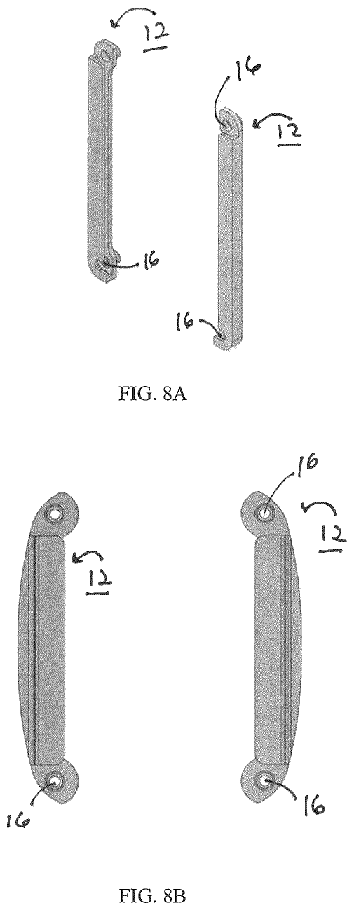

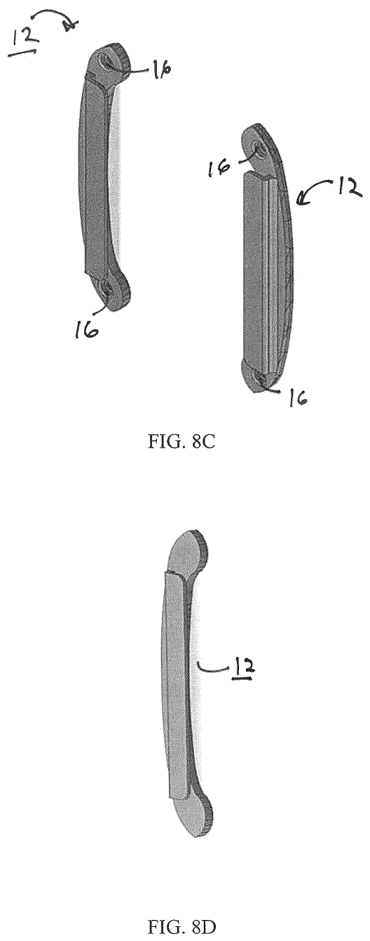

The bracket 10 includes two (2) opposing sides 12 and a bottom 14 connecting the opposing sides 12. Although not required, generally the sides 12 will be mirror images of one another. Various alternate embodiments of the sides 12 are shown in FIGS. 8A-8D. Finally the bracket 10 contains an open end where (as shown and described herein) the insert 24 may be disposed.

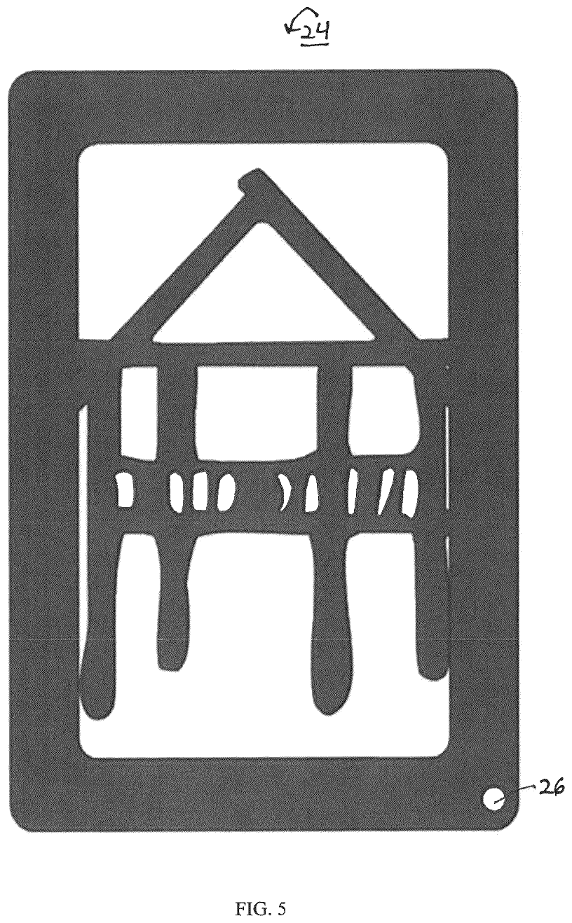

In some embodiments, the bracket 10 also includes one or more apertures 16 which allow for a fastener (such as screws or bolts) to pass through the aperture 16 and be used to affix the bracket 10 to an automobile. For example, in the embodiment shown in FIGS. 1-7, the bracket 10 has four (4) apertures 16 generally located at the corners of the bracket 10. The apertures 16 will generally align with the fasteners that secure a taillight to an automobile. This alignment allows the bracket 10 to be placed over the taillight with the apertures aligned properly and, after removal of the fasteners which secure the taillight, the bracket 10 and be affixed to the automobile by passing the fasteners through the apertures 16 and into the factory provided taillight fastener openings. This method of attachment allows for the affixation of the bracket 10 and the taillight to the automobile. It also allows for the removal of the bracket if so desired in the future. In one embodiment, shown in FIG. 4 for example, the rear of the bracket 10 includes a rearward projection at each aperture 16 which aids in positioning the bracket 10 over the fasteners for the taillight.

In an alternate embodiment, the bracket 10 does not include the apertures but is rather secured to the automobile by tape or other magnetic means. This embodiment of the bracket 10 may be especially useful for affixation to flat or nearly flat surfaces (such as doors) on an automobile.

Finally, in yet another embodiment, the bracket 10 may include the apertures 16 for affixation over a taillight and also include other means of securement to flat or nearly flat surfaces of the automobile. This embodiment is especially useful in that it allows a user to select where on their automobile they want to affix the bracket or change its location over time.

The bracket 10 includes a slot 18 one the sides 12 and the bottom 10. The slot 18 further includes a ledge 20 disposed towards the back of the bracket and an outer surface 22 disposed opposite the ledge 20 near the front of the bracket. The ledge 20 and the outer surface 22 define the boundaries of the slot 18.

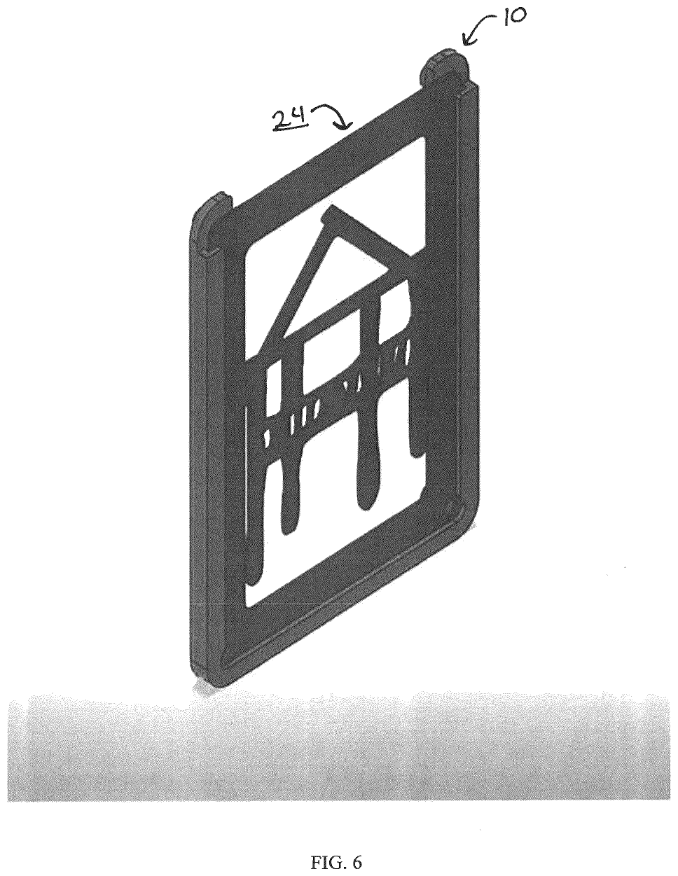

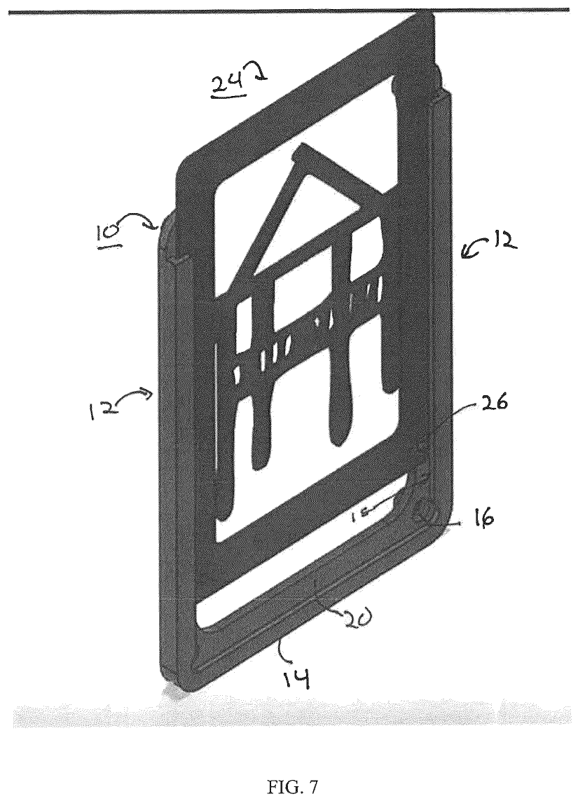

The present disclosure also includes an insert 24 which is removably disposed into the bracket 10 via the slot 18 as shown herein. In one embodiment, the insert 24 is slide vertically into the slot 18 from above (as shown in FIGS. 6 and 7). The insert 26 optionally includes at least one insert aperture 26 that aligns with at least one aperture 16 on the bracket 10. In a similar method as with the bracket 10, a fastener may be passed through the insert aperture 26 to aid in securement of the insert 24. In an alternate embodiment, the insert 24 does not include an insert aperture 26 but is rather held in place via gravity.

There are many ornamental designs possible for the insert 24 which allow for personalization. For example, the insert 24 could be designed to show fandom for a sports team or a particular player, a state, a city, an activity or a holiday. The myriad of possibilities of personalized designs for the insert 24 should not be considered limiting in scope for this disclosure.

In alternate embodiments, the insert 24 need not be ornamental but rather an provide an utilitarian purpose and allow for the securement of articles to the automobile. For example, an insert 24 may include a drink or can holder (which allows a user to rest a can or drink in it when outside of the automobile when camping or tailgating) or a holster for a firearm which allows a user to have their firearm readily accessible when outside of their vehicle.

The bracket 10 and insert 24 may be manufactured from the same or similar materials in some embodiments while in other embodiments, they may be manufactured from different materials.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

The terms “about” and “approximately” shall generally mean an acceptable degree of error or variation for the quantity measured given the nature or precision of the measurements. Typical, exemplary degrees of error or variation are within 20 percent (%), preferably within 10%, more preferably within 5%, and still more preferably within 1% of a given value or range of values. Numerical quantities given in this description are approximate unless stated otherwise, meaning that the term “about” or “approximately” can be inferred when not expressly stated. As used herein, the singular forms “a”, “an” and “the” are intended to include the plural forms as well, unless the context clearly indicates otherwise.

Although particular embodiments of the present disclosure have been described, it is not intended that such references be construed as limitations upon the scope of this disclosure except as set forth in the claims.

I claim:

1. A device for securing an insert to an automobile, said device comprising two (2) opposing sides 12 and a bottom 14 connecting the opposing sides 12.

2. The device of claim 1 wherein the sides are mirror images of one another.

3. A device for securing an insert over the taillight of an automobile, said device comprising two (2) opposing sides 12 and a bottom 14 connecting the opposing sides 12.
